(19) United States
(12) Patent Application Publication
(10) Pub. No.: US 2025/0310670 A1
(43) Pub. Date: Oct. 2, 2025

(54) PON WITH LEGACY CPE

(71) Applicant: ARRIS Enterprises LLC, Horsham, PA (US)

(72) Inventors: Bruce C. PRATT, Bedford, NH (US); David BOWLER, Stow, MA (US)

(73) Assignee: ARRIS Enterprises LLC, Horsham, PA (US)

(21) Appl. No.: 18/862,899

(22) PCT Filed: Apr. 14, 2023
(86) PCT No.: PCT/US2023/018702

§ 371 Date: Nov. 4, 2024

Related U.S. Application Data
(60) Provisional application No. 63/338,816, filed on May 5, 2022.

(51) Int. Cl. H04Q 11/00; H04B 10/27; H04L 12/28

(52) U.S. Cl. CPC H04Q 11/0067; H04B 10/27; H04L 12/2801; H04Q 2011/0064; H04Q 2011/0086

(57) ABSTRACT

A communication device that includes a tap having an optical network terminal and a termination system to provide data communication between customer premise equipment and an optical line terminal. The termination system includes limited functionality of a CMTS.

### CROSS REFERENCE TO RELATED APPLICATIONS

The present application is a 371 National Stage Patent Application claiming priority to International Patent Application No. PCT/US23/18702, filed Apr. 14, 2023, which claims the benefit of U.S. Provisional Patent Application No. 63/338,816 filed May 5, 2022.

### BACKGROUND

The subject matter of this application relates to a passive optical network that operates in combination with DOCSIS based consumer premise equipment devices.

A passive optical network (PON) is often employed as an access network, or a portion of a larger communication network. The communication network typically has a high-capacity core portion where data or other information associated with telephone calls, digital television, and Internet communications is carried substantial distances. The core portion may have the capability to interact with other networks to complete the transmission of telephone calls, digital television, and Internet communications. In this manner, the core portion in combination with the passive optical network enables communications to and communications from subscribers (or otherwise devices associated with a subscriber, customer, business, or otherwise).

The access network of the communication network extends from the core portion of the network to individual subscribers, such as those associated with a particular residence location (e.g., business location). The access network may be wireless access, such as a cellular network, or a fixed access, such as a passive optical network or a cable network.

Referring to FIG. 1, in a PON 10, a set of optical fibers and passive interconnecting devices are used for most or all of the communications through the extent of the access network. A set of one or more optical network terminals (ONTs) 11 are devices that are typically positioned at a subscriber's residence location (e.g., or business location). The term “ONT” includes what is also referred to as an optical network unit (ONU). There may be any number of ONTs associated with a single optical splitter 12. By way of example, 32 or 64 ONTs are often associated with the single network optical splitter 12. The optical splitter 12 is interconnected with the respective ONTs 11 by a respective optical fiber 13, or otherwise a respective fiber within an optical fiber cable. Selected ONTs may be removed and/or added to the access network associated with the optical splitter 12, as desired. There may be multiple optical splitters 12 that are arranged in a cascaded arrangement.

The optical fibers 13 interconnecting the optical splitter 12 and the ONTs 11 act as access (or “drop”) fibers. The optical splitter 12 is typically located in a street cabinet or other structure where one or more optical splitters 12 are located, each of which are serving their respective set of ONTs. In some cases, an ONT may service a plurality of subscribers, such as those within a multiple dwelling unit (e.g., apartment building). In this manner, the PON may be considered a point to multipoint topology in which a single optical fiber serves multiple endpoints by using passive fiber optic splitters to divide the fiber bandwidth among the endpoints.

An optical line terminal (OLT) 14 is located at the central office where it interfaces directly or indirectly with a core network 15. An interface 16 between the OLT 14 and the core network 15 may be one or more optical fibers, or any other type of communication medium. The OLT 14 forms optical signals for transmission downstream to the ONTs 11 through a feeder optical fiber 17, and receives optical signals from the ONTs 11 through the feeder optical fiber 17. The optical splitter 12 is typically a passive device that distributes the signal received from the OLT 14 to the ONTs 11. Similarly, the optical splitter 12 receives optical signals from the ONTs 11 and provides the optical signals though the feeder optical fiber 17 to the OLT 14. In this manner, the PON includes an OLT with a plurality of ONTs, which reduces the amount of fiber necessary as compared with a point-to-point architecture.

As it may be observed, an optical signal is provided to the feeder fiber 17 that includes all of the data for the ONTs 11. Accordingly, all the data being provided to each of the ONTs is provided to all the ONTs through the optical splitter 12. Each of the ONTs selects the portions of the received optical signals that are intended for that particular ONT and passes the data along to the subscriber, while discarding the remaining data. Typically, the data to the ONTs are time division multiplexed to the feeder fiber 17, and similarly time division multiplexed to each of the ONTs.

Upstream transmissions from the ONTs 11 through the respective optical fibers 13 are typically transmitted in bursts according to a schedule provided to each ONT by the OLT. In this way, each of the ONTs 11 will transmit upstream optical data at different times. In some embodiments, the upstream and downstream transmissions are transmitted using different wavelengths of light so that they do not interfere with one another. In this manner, the PON may take advantage of wavelength-division multiplexing, using one wavelength for downstream traffic and another wavelength for upstream traffic on a single mode fiber.

The schedule from the OLT allocates upstream bandwidth to the ONTs. Since the optical distribution network is shared, the ONT upstream transmission would likely collide if they were transmitted at random times. The ONTs typically lie at varying distances from the OLT and/or the optical splitter, resulting in a different transmission delay from each ONT. The OLT measures the delay and sets a register in each ONT to equalize its delay with respect to the other ONTs associated with the OLT. Once the delays have been accounted for, the OLT transmits so-called grants in the form of grant maps to the individual ONTs. A grant map is a permission to use a defined interval of time for upstream transmission. The grant map is dynamically recalculated periodically, such as for each frame. The grant map allocates bandwidth to all the ONTs, such that each ONT receives timely bandwidth allocation for its service needs. Much of the data traffic, such as browsing websites, tends to have bursts and tends to be highly variable over time. By way of a dynamic bandwidth allocation (DBA) among the different ONTs, a PON can be oversubscribed for upstream traffic.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates a network that includes a passive optical network.

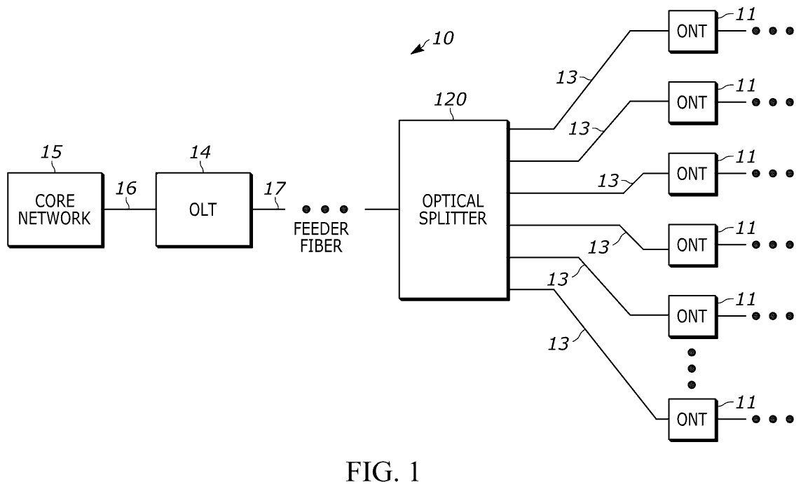

FIG. 2 illustrates an integrated video delivery and Cable Modem Termination System.

FIG. 3 illustrates a distributed video delivery and Cable Modem Termination System.

FIG. 4 illustrates a combination PON network and CMTS network.

FIG. 5 illustrates a tap with an ONT and a termination system.

### DETAILED DESCRIPTION

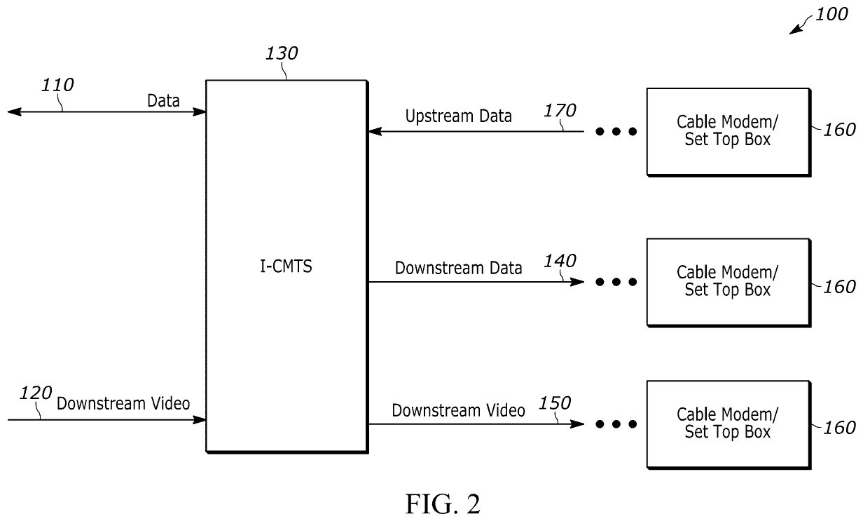

Referring to FIG. 2, an integrated CMTS (e.g., Integrated Converged Cable Access Platform (CCAP)) 100 may include data 110 that is sent and received over the Internet (or other network) typically in the form of packetized data. The integrated CMTS 100 may also receive downstream video 120, typically in the form of packetized data from an operator video aggregation system. By way of example, broadcast video is typically obtained from a satellite delivery system and pre-processed for delivery to the subscriber though the CCAP or video headend system. The integrated CMTS 100 receives and processes the received data 110 and downstream video 120. The CMTS 130 may transmit downstream data 140 and downstream video 150 to a customer's cable modem and/or set top box 160 through a RF distribution network, which may include other devices, such as amplifiers and splitters. The CMTS 130 may receive upstream data 170 from a customer's cable modem and/or set top box 160 through a network, which may include other devices, such as amplifiers and splitters. The CMTS 130 may include multiple devices to achieve its desired capabilities. It is noted that the data and video for different cable modem and/or set top box are typically transmitted on a single cable until a split occurs. Also, for the CMTS, there is typically a video source in parallel, such as an EdgeQAM.

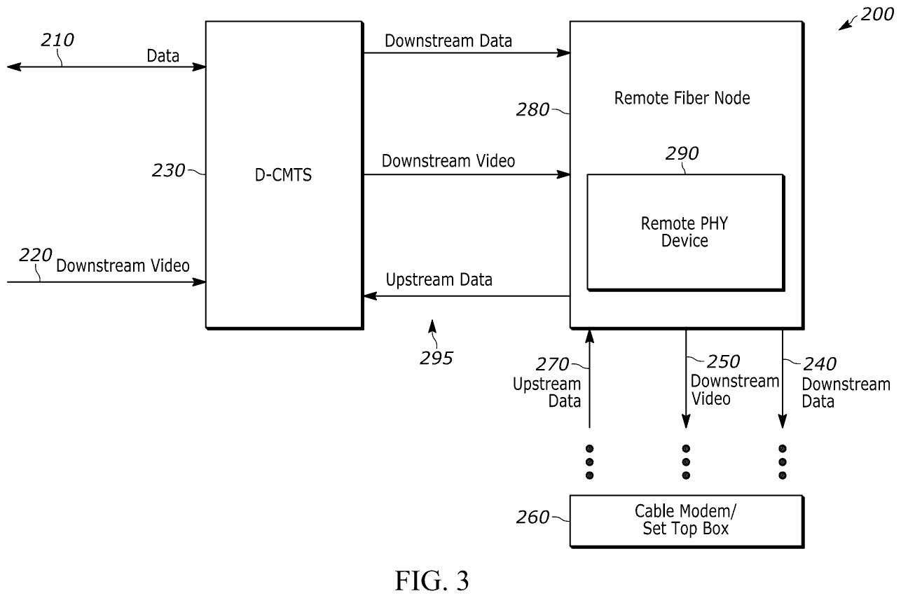

Referring to FIG. 3, as a result of increasing bandwidth demands, limited facility space for integrated CMTSs, and power consumption considerations, it is desirable to include a Distributed Cable Modem Termination System (D-CMTS) 200 (e.g., Distributed Converged Cable Access Platform (CCAP)). CableLabs specifications refer to this architecture as a Distributed CCAP Architecture (DCA) in the Flexible MAC Architecture (FMA) specifications. In general, the CMTS is focused on data services while the CCAP further includes broadcast video services. The D-CMTS 200 distributes a portion of the functionality of the I-CMTS 100 downstream to a remote location, such as a fiber node, using network packetized data. An exemplary D-CMTS 200 may include a remote PHY architecture, where a remote PHY (R-PHY) is preferably an optical node device that is located at the junction of the fiber and the coaxial. In general the R-PHY often includes the PHY layers of a portion of the system. The D-CMTS 200 may include a D-CMTS 230 (e.g., core) that includes data 210 that is sent and received over the Internet (or other network) typically in the form of packetized data. The D-CMTS 230 is referred to as the Remote MAC Core (RMC) in the Flexible MAC Architecture (FMA) CableLabs specifications. The D-CMTS 200 may also receive downstream video 220, typically in the form of packetized data from an operator video aggregation system. The D-CMTS 230 receives and processes the received data 210 and downstream video 220. A remote fiber node 280 preferably include a remote PHY device (RPD) 290. The RPD 290 may transmit downstream data 240 and downstream video 250 to a customer's cable modem and/or set top box 260 through a network, which may include other devices, such as amplifier and splitters. The RPD 290 may receive upstream data 270 from a customer's cable modem and/or set top box 260 through a network, which may include other devices, such as amplifiers and splitters. The RPD 290 may include multiple devices to achieve its desired capabilities. The RPD 290 primarily includes PHY related circuitry, such as downstream QAM modulators, upstream QAM demodulators, together with pseudowire logic to connect to the D-CMTS 230 using network packetized data. The RPD 290 and the D-CMTS 230 may include data and/or video interconnections, such as downstream data, downstream video, and upstream data 295. It is noted that, in some embodiments, video traffic may go directly to the RPD thereby bypassing the D-CMTS 230. In some cases, the remote PHY and/or remote MACPHY functionality may be provided at the head end. Also, for the CMTS, there is typically a video source in parallel, such as an EdgeQAM.

By way of example, the RPD 290 may covert downstream DOCSIS (i.e., Data Over Cable Service Interface Specification) data (e.g., DOCSIS 1.0; 1.1; 2.0; 3.0; 3.1; and 4.0 each of which are incorporated herein by reference in their entirety), video data, out of band signals received from the D-CMTS 230 to analog for transmission over RF or analog optics. By way of example, the RPD 290 may convert upstream DOCSIS, and out of band signals received from an analog medium, such as RF or linear optics, to digital for transmission to the D-CMTS 230. As it may be observed, depending on the particular configuration, the R-PHY may move all or a portion of the DOCSIS MAC and/or PHY layers down to the fiber node.

The amount of data services supported by DOCSIS based networks over time has been increasing. To support the ever-increasing data capacity needs, the DOCSIS standard has likewise been evolving in a manner to support the increasing data capacity needs. A single-carrier quadrature amplitude modulation (SC-QAM) based transmission of DOCSIS 3.0 is giving way to orthogonal frequency division multiplexing (OFDM) and orthogonal frequency division multiple access (OFDMA) of DOCSIS 3.1, to support greater megabits per second (Mbps) per mega-hertz (MHz) of spectrum. Furthermore, more MHz of radio frequency (RF) spectrum yields more Mbps, thus a wider spectrum, for both downstream (DS) and upstream (US) transmission is another manner in which the DOCSIS standard has evolved. For example, the DOCSIS standard has evolved from (1) 5-85 MHz US with 102-1002 MHz DS supported by DOCSIS 3.0 to (2) 5-204 MHz US with 258-1218 MHz DS of DOCSIS 3.1, and (3) 5-684 MHz US with 54-1794 MHz DS of DOCSIS 4.0. Transmitted spectrum width increase, in DS especially, affects how the network is architected. The DOCSIS 3.1 to DOCSIS 4.0 transition, from 1,218 MHz highest DS frequency to 1,794 MHz highest DS frequency, envisions a change from a centralized access architecture (CAA) to distributed access architecture (DAA), in order to support higher OFDM modulation formats and thus improved spectral density at the DAA nodes.

Nodes are hybrid fiber coax (HFC) devices in which the fiber links (or otherwise) transition to the coaxial cables, and as such nodes convert optical signals (or otherwise) into the RF signals and/or convert RF signals (or otherwise) to optical signals. Also, the nodes condition RF signals for transmission over coaxial cables, for an eventual delivery to subscribers, situated at the other end of the coaxial portion of the HFC network. The node may be configured based upon the environment, such as for example, a strand, an underground vault, or a street cabinet. The node may be configured with any suitable number of ports, such as one, two, three, four, or more, coaxial ports.

When a service provider considers providing data connectivity using PON to a neighborhood, there is a substantial upfront expense and time involved in the installation of the fiber optical cables and other components of the network to each of the residences (or otherwise businesses). By way of example, the fiber needs to be routed from a central office to the neighborhood, together with a set of splitters and/or other components, to provide fiber to each of the residences. The fiber is often routed by being suspended from adjacent telephone poles or otherwise buried in a conduit within the ground. For each subscriber, an optical fiber needs to be routed in some manner from the subscriber's residence to a tap at the telephone pole or otherwise, generally referred to as a drop. This fiber drop tends to be expensive and burdensome to install, especially in the case of a multi dwelling unit (e.g., apartment complex, high rise set of condos, or otherwise).

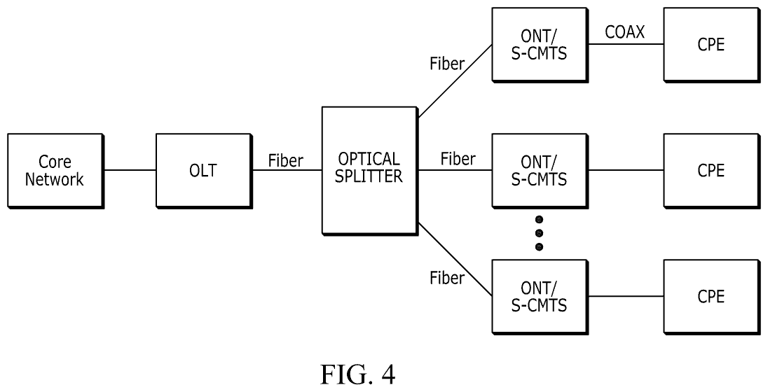

Referring to FIG. 4, after consideration of the expense involved in running optical fiber to the residences, it was determined that a simplified cable modem terminal system (CMTS) (generally referred to as a termination system with any desired components of the CMTS omitted, as desired), where a traditional CMTS is a large computationally complex device housed in an environmentally controlled building, could be included at each tap for each respective residence. In this manner, the simplified CMTS would be arranged at each tap of the PON network to provide communication to and from the consumer premise equipment (CPE) (e.g., cable modem and/or set top box) at the corresponding residence using the traditional DOCSIS communication protocol, or a subset thereof. In some embodiments, the simplified CMTS may include a plurality of ports, each of which is provided to a single consumer premise equipment device. The tap would include an ONT provided with communications to and receive communications from the core network using an optical fiber of a PON network. In particular, the ONT includes sufficient portions of the traditional ONT in order to provide communication to and receive communications from the core network and/or OLT. The ONT receives the data from the core network on an optical fiber and converts the data, as appropriate, which is provided to the simplified CMTS which in turn provides data to the CPE of the residence based upon a DOCSIS protocol over a coaxial cable. The CPE of the residence provides data to the simplified CMTS over the coaxial cable, which receives the data and converts the data, as appropriate, which is provided to the ONT which in turn provides data to the core network and/or OLT over the optical fiber on the PON network. In this manner, the core network and/or OLT in combination with the simplified CMTS and ONT provides data to the CPE of a residence and receive data from the CPE of the residence over existing coaxial cables. Using the simplified CMTS alleviates the need to install optical fiber to the residence (e.g., inclusive of multi-dwelling structures, businesses, or otherwise), including the respective expense and time associated therewith, because the existing coaxial cable may be used.

The traditional CMTS is designed from a standpoint of including time domain multiple access (TDMA) and frequency division multiple access (FDMA) to provide data communications to and from a large number of different consumer premise equipment devices of respective residences with a relatively limited available bandwidth so that the data communications to and from each of the large number of different consumer premise equipment devices don't interfere with one another. Further, in some cases multiple CPE devices may send data at the same time, each of which are using different frequencies. Further, in some cases the same CPE device may send data using multiple frequencies at the same time, while other CPE devices are not using the same frequencies. To optimize the limited bandwidth for the relatively large number of devices, a complicated dynamic bandwidth allocation (DBA) is employed, to account for the different CPE devices, different frequencies to be used by each CPE device, and timing for such transmission for each CPE device, that is based upon a centralized reservation-based approach. Also, the CMTS includes an associated layer 3 routing capability, which tends to complicated and expensive.

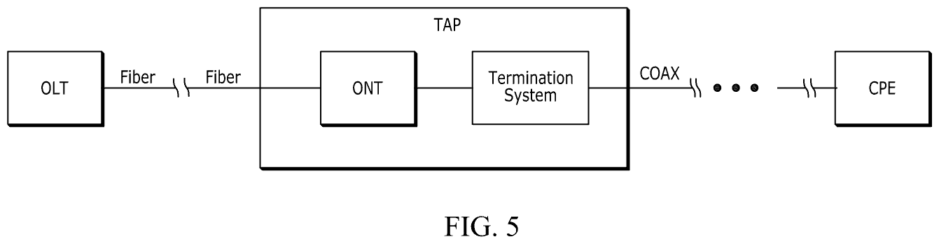

Referring to FIG. 5, the simplified CMTS may be designed to provide a 1 to 1 communication between the simplified CMTS (or a respective port of the simplified CMTS having multiple ports) and a corresponding consumer premise equipment device. By removing the capability of providing communication with a plurality of different consumer premise equipment devices, there is no longer a need for dynamic bandwidth allocation to enable allocation among a plurality of different CPE devices, which can readily be omitted from the simplified CMTS. Also, the simplified CMTS no longer would need an associated layer 3 routing capability, which combines the functionality of a switch and a router, for its communications. By removing the capability of providing communication with a plurality of different consumer premise equipment devices, there is no longer a need for time division multiple access to enable allocation among a plurality of different CPE devices. By removing the capability of providing communication with a plurality of different consumer premise equipment devices, there is no longer a need for frequency division multiple access among a plurality of different CPE devices.

As a result of the simplification of the CMTS, which removes much of the complexities associated with a traditional CMTS, all of the downstream data can be sent from the simplified CMTS to the consumer premise equipment device using all or substantially all of the available downstream bandwidth. As a result of the simplification of the CMTS, which removes much of the complexities associated with a traditional CMTS, all of the upstream data can be sent from the consumer premise equipment device to the simplified CMTS using all or substantially all of the available upstream bandwidth. Preferably, the simplified CMTS signals the CPE device to make use of a plurality of, and preferably all of, the available channels which may be bonded together for the upstream and downstream data communication.

Traditionally, CPE devices manage their bandwidth requirements using a request-grant arbitration mechanism. The CPE device makes a request to the CMTS for an allocation of bandwidth. The CMTS inspects the content of the request to determine the requested allocation of bandwidth. The CMTS issues grants to the CPE device using an upstream bandwidth allocation map (MAP) message based upon the requested allocation. The CPE device then transmits data during its grant period indicated by the MAP message. This process may be further complicated by expiration times, retries, queuing of data, enqueuing of data, etc. The simplified CMTS may support this type of request-grant arbitration mechanism, if desired. However, such a request-grant arbitration tends to require computational resources to determine the bandwidth allocation.

In contrast to the traditional mechanism of inspecting the content of the request to determine the requested allocation of bandwidth, the simplified CMTS may receive the request and in response thereto issue the grant to the CPE device using an upstream bandwidth allocation map (MAP) message without inspecting the request to determine the amount of bandwidth requested. By providing the upstream bandwidth allocation map (MAP) message to the CPE device without inspecting the request to determine the amount of bandwidth requested decreases the time to provide a suitable response and also reduces the computational expenses associated with inspection of such a request message. The simplified CMTS may determine a suitable bandwidth allocation in the bandwidth allocation map (MAP) message, which is preferably all of the bandwidth the CPE device is capable of using because there is only a single CPE device using the interconnection with the simplified CMTS.

If desired, in contrast to sending out the upstream bandwidth allocation map (MAP) message in response to receiving a request from the CPE device, the simplified CMTS may provide an upstream bandwidth allocation map (MAP) message on a periodic basis that is not in response to receiving a request. In this case, the request may be used as the basis of providing some upstream bandwidth allocation map (MAP) messages, or otherwise may be discarded, if desired. By way of example, the simplified CMTS may provide an unsolicited data grant (e.g., unsolicited grant synchronization) to the CPE device. If desired, the simplified CMTS may modify its allocation of bandwidth to the CPE device based upon the allocation of data on the PON network.

The ONT that receives and sends PON signals, and the simplified CMTS may integrated into the same housing that is installed for a particular residence. For example, the simplified CMTS may be integrated into a faceplate that is detachably engageable with the tap. In this manner, the simplified CMTS may use the power available at the tap for its operation.

Moreover, each functional block or various features in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A communication device comprising:
(a) said communication device including an optical network terminal capable of receiving optical digital data from an optical line terminal from a first optical fiber connection and provide optical digital data to said optical line terminal;
(b) said communication device including a termination system capable of receiving coaxial digital data from a customer premise equipment based upon a DOCSIS protocol from a first coaxial connection and provide coaxial digital data to said customer premise equipment based upon said DOCSIS protocol;
(c) said optical network terminal receiving first optical digital data from said optical line terminal and said termination system providing first coaxial digital data to said customer premise equipment representative of said first optical digital data;
(d) said termination system receiving second coaxial digital data from said customer premise equipment and said optical network terminal providing second optical digital data to said optical line terminal representative of said first coaxial digital data;
(e) wherein said termination system is free from including at least one of:
(i) a capability of providing dynamic bandwidth allocation among a plurality of said consumer premise equipment devices each of which are associated with a different subscriber;
(ii) a capability of providing communication among a plurality of different said consumer premise equipment devices each of which are associated with a different subscriber for a single port of said termination system;
(iii) a capability of supporting time division multiple access among a plurality of said consumer premise equipment devices each of which are associated with a different subscriber;
(iv) a capability of supporting frequency division multiple access among a plurality of said consumer premise equipment devices each of which are associated with a different subscriber.

2. The communication device of claim 1 wherein said termination system is free from including said capability of providing dynamic bandwidth allocation among said plurality of said consumer premise equipment devices.

3. The communication device of claim 1 wherein said termination system is free from including said capability of providing communication among said plurality of different said consumer premise equipment devices for said single port of said termination system.

4. The communication device of claim 1 wherein said termination system is free from including said capability of supporting time division multiple access among said plurality of said consumer premise equipment devices.

5. The communication device of claim 1 wherein said termination system is free from including said of supporting frequency division multiple access among said plurality of said consumer premise equipment devices.

6. The communication device of claim 1 wherein said termination system manages bandwidth of said consumer premise equipment device based upon a request-grant arbitration mechanism.

7. The communication device of claim 6 wherein said termination system receives a request for an allocation of bandwidth from said consumer premise equipment device.

8. The communication device of claim 7 wherein said termination system provides a grant of bandwidth to said consumer premise equipment device in response to said request for allocation of bandwidth based upon inspecting said request for allocation of bandwidth for an amount of bandwidth requested.

9. The communication device of claim 8 wherein said grant is in the form of an upstream bandwidth allocation map message.

10. The communication device of claim 7 wherein said termination system provides a grant of bandwidth to said consumer premise equipment device in response to receiving said request for allocation of bandwidth without inspecting said request for allocation of bandwidth for an amount of bandwidth requested.

11. The communication device of claim 1 wherein said termination system manages bandwidth of said consumer premise equipment based upon providing an unsolicited data grant to said consumer premise equipment device.

12. The communication device of claim 11 wherein said unsolicited data grant is an unsolicited grant synchronization to said consumer premise equipment device.
